(19) United States
(12) Patent Application Publication
(10) Pub. No.: US 2004/0070920 A1
(43) Pub. Date: Apr. 15, 2004

(54) Personal computer

(76) Inventor: Adolf Flueli, Winterhur (CH)

Correspondence Address: BURNS DOANE SWECKER & MATHIS L L P, POST OFFICE BOX 1404, ALEXANDRIA, VA, 22313-1404, US

(21) Appl. No.: 10/451,401

(22) PCT Filed: Dec. 21, 2001
(86) PCT No.: PCT/CH01/00738

(30) Foreign Application Priority Data
Dec. 21, 2000 (CH) 2524/00

(51) Int. Cl. H01G 9/00

(52) U.S. Cl. 361/500

(57) ABSTRACT

The invention relates to a personal computer and its portable versions, such as laptops and handheld computers, comprising at least two independent subsystems (8) in addition to a microprocessor (2). Each existing subsystem (8) is based on a separate, independent classification of the data contained therein as a result of the latter's security-specific sensitivity. Each subsystem (8) comprises at least one individual physical and/or virtual storage medium (9). Each subsystem (8) contains at least one individual integrated operating system (10). According to requirements, the subsystems (8) can be started and prepared for operation, or switched to standby mode jointly or independently of one another, or started and operated jointly or independently of one another, or switched to standby mode from operational mode, or shutdown jointly or independently of one another, or shutdown from standby mode jointly or independently of one another.

The present invention is directed to a personal computer, including its portable variants, like laptops.

By the term “personal computer” for the purpose of the present invention are understood all units and/or devices for the individual data processing and data storage, as they are summarized by the generic term “individual personal computer” as autarkic, microprocessor-based, stationary or mobile single work station. These individual personal computers are usually denoted in dependence of their provenance and source of literature “PC” (personal computer), “workstation”, “Macintosh” etc.. Their miniaturized, mobile versions are denoted “laptop”, “notebook”, “subnotebook”, “handheld computer”, “palmtop computer”, “personal digital assistant”, PDA, “pen computer”, “organizer”, “notepad”, “minicomputer”, etc.. All forms mentioned before of these individual personal computers make possible both an individual data processing and a storage of data.

Such personal computer usually encompass with their stationary versions as basic elements a cabinet, the power supply and the voltage supply needed for the operation, the primary computer unit needed for the application, peripheral storage media, such as hard disks, and if necessary network interfaces, as well as the further peripheral devices, needed for the operation, such as display, keyboard, computer mouse, as well as further peripheral data readers and data storage devices if necessary.

Such personal computers usually encompass with their mobile versions, for example “laptop”, “notebook”, “sub notebook”, usually a specifically designed cabinet. Into this cabinet are integrated the basic elements mentioned above, a keyboard and a usually hinged display. Furthermore, there may be present a computer mouse, in the form of a touchpad, and various other interfaces. These interfaces are used to connect peripheral devices, for example devices for communication, in particular for the mobile communication.

Such personal computers usually encompass in their miniaturized mobile versions, for example as so-called “handheld computers”, “palm top computers”, “personal digitally assistant”, PDA, “organizer”, a specifically designed cabinet. Into this cabinet are integrated the basic elements as mentioned above, as well as further miniaturized or multi-functional elements. An example of such an element is a display, by which the data entry can be made with the help of a so-called “digital pen”, so that no separate keyboard is needed for the data entry. Furthermore different interfaces can be present. These interfaces are used to connect peripheral devices, for example devices for communication, in particular for the mobile communication.

Other generations of such miniaturized mobile versions of personal computers besides of the basic elements and the multifunctional elements mentioned above have interfaces and devices integrated for mobile communication. This allows for a permanent connection of such a personal computers to communication channels as characterized by the concept “always on”. Therefore fusion of mobile phone and “minicomputer” to a “ubiquitous computer” is the result.

Personal computers, in the following part abbreviated as PC, today have become a standard in business and at home. In connection with their broad availability in relation to up to date communication, for example internet and other forms of networks as well as further data communication channels, various security problems occur, in particular concerning the access through third party over the internet respectively network connections to the data stored in the PC. In connection with the increasingly more attractive connections, in particular also for the internet access over cable systems as e.g. cable tv, or electrical power lines (power line communication, PLC), that are equivalent to a leased line these risks become more and more important. Also the increasing numbers of Local Areas Networks (LANs) and their greater complexity and their intensive use mean a growing risk potential.

A present philosophy asks to store as many data as possible centrally. On demand the data is accessed decentralized using networks and is processed locally. Depending on the sensitivity of the data and besides of further options for data security appropriate encryption and authentication is required for persons who access the data. Together with the permanent expansion of the networks also the risks rise that sensitive data can not be protected on a long term or at any time against access by unauthorized third party.

Permanent storing of usually large amount of user data, the user software as well as the operating systems of a PC generally are installed on at least one stationary hard disk, or on removable hard disks or external add-on equipment. The storing of user data may also be performed usually on individual media, which for this purpose is plugged into the PC or its drives, respectively, so-called removable storage media, for example on specific versions of compact disks, like CD-R, CD-RW, digital versatile disk, DVD, disks, memory sticks etc., and occasionally also on magnetic tape drives for backups.

The media mentioned above for permanent storage of large amount of data are summarized under the generic term “serial access memory”.

In addition personal computers have a variety of main memory/working memory and buffers/intermediate memory, also named registers, cache or main store, which serve for the internal data processing of the core system, and which are summarized as memory category under the generic term “random access memory”, RAM. In these memories are sequentially buffered and called up both the program data and the user data during their processing by the PC.

A substantial characteristic of the so-called volatile data memory, RAM, consists in the complete loss of data in the case of a power cut. Further volatile data memory, CMOS, achieve an indifferent memory status during a power cut, and are to be deleted preferably manually, by a so-called active deletion.

In addition PC's have also at least one further storage element, which is usually installed in such a way on the mainboard as ROM, EPROM or EEPROM or their most recent versions, such as flash-ROM, etc., that certain basic data and basic programs for example the so-called “basic input/output system”, BIOS, the system time etc., which are necessary for the initial start-up/boot process of the PC, are permanently stored.

A substantial characteristic of the so-called resident data memory, ROM, is the preservation of the most recently stored data, even in the case of a power cut.

In general main storage media, main memory and the buffers, L1-Cache and L2-Cache, and the processor, CPU, together with their tightly-coupled elements, for example the appropriate store management, MMU, as core system are connected by a fast bus connection and are installed on a motherboard, main board, together with further controllers and elements, for example the sockets for I/O cards, and together with further elements, such as graphic systems, form the primary computer unit.

The operating system needed for the initial start-up/boot process and use of the PC usually is installed on a permanent bootable storage media, for example a hard disk, or if several hard disks are available usually on the primary hard disk.

After starting the operating system all hard disks are usually selectable freely. In addition, it is also possible that at least one hard disk or a part of a hard disk, named partition, is software protected against access, e.g. by a password.

Crucial to internet access or internal network connections of a PC is the necessary configuration and specific software, e.g. the drivers for the modem, the drivers for the ISDN cards, respectively the drivers for the network interface cards for the connection from the PC to a network or to the internet via cable modem. Said configuration data and software are installed on one of the hard disks or on the primary hard disk of the respective PC.

The disadvantage of this means that during active network connection in principle and with appropriate effort all data on the operating PC may be viewed indirectly by appropriate software or may be dumped to the interested third party via espionage programs, for example by “trojans” or “cookies”, unnoticed by the PC user, or if necessary after overcoming a possible access protection on that location also may be dispatched directly by an unauthorized third party from this PC.

Various software solutions exist like “firewalls” etc., in order to prevent such external interferences and attacks. However, these software solutions cannot ensure an absolute protection against access, because the status of the hacker software and the methodology of the hackers and crackers, respectively always allows for a potential advantage on the side of the aggressor, for example by the use of new unknown viruses. Furthermore software solutions as e.g. anti-virus programs need to be updated periodically in order to ensure their proper function.

In addition the application of these software solutions as well as possible encryption programs both cause an additional effort for installation and system administration and an additional individual effort for handling during the operation of the computer. In addition installation of these software solutions during the following operation of the PC induce a loss of performance.

In addition such “firewalls” that help to achieve a certain degree of protection are relatively extensive regarding software and hardware equipment which on one hand requires appropriate investments and on the other hand restricts their application mainly to stationary applications in regard to hardware requirements. Thus, the mobile personal computers during their operation outside an environment protected by firewalls are protectable less satisfactory, in particular during their sequential connection to the internet and during their sequential or permanent connection via mobile phones or other wireless networks.

Within solely internal networks access to the individual or personal data or to certain partial amounts of data, for example for certain user groups, usually is protected by a password and by the appropriate software. Since also the administration of the access authorizations is solely software controlled, the appropriate authorizations for the system management, and in particular the therefore additionally needed access authorizations, usually also in the form of passwords, are the given and by crackers preferred weak points. In addition to certain user groups, such as the system administrator with its access authorizations, in principal usually all the data stored in the corresponding network are accessible for insight. The accessibility is given in particular when the appropriate PC is in operation. The accessibility is also given on an indirect way, when the PC is not in operation, for example by access to the backup-data, which are centrally collected by automatic periodic backups.

Backup solutions for PC's that are connected to networks, usually are centralized solutions. Mobile PC's can be connected for this purpose periodically to networks. As long as the PC runs without any data losses or without failure of the hard disk drives, HDD, this does not represent a special problem with the exception to the already mentioned safety problem in handling sensitive data. As soon as however a partial loss of data or a HDD defect occurs, especially during mobile use of PC's, an immediate recovery of the interference or the access to backup data and the immediate recovery of the lost data is normally not possible without the assistance of a system manager. Such a loss can cause an enormous damage regarding the resulting loss of working time and efforts necessary until recovery of the break-down.

In addition with PC's, which are connected to networks and depending on their configuration and that of the network during the operation of the PC over the network data transfer is possible that is not visible and not noticed by the user and which are running unnoticed in the background. Usually for the user also the scope of the network he is connected to with his PC is neither known nor obvious nor easily recognizable. Furthermore a PC is usually connected with a single network and this connection is not at full extent observable and also not changeable without further manipulations.

With a combination of networks that provide both internal and external connections authorized and unauthorized accesses are possible. There is necessary a permanent and highly qualitative and disciplined administration of the networks and of the total amount of the data in it. The more complex and the more extensive such networks are installed the more vulnerable they get on weak points, for example concerning data security, in particular also with upgrades and extensions of the networks. Any small or short time failure that occurs enables third party an accessibility on the data.

The processing of all data both on common media and their transmission on common networks causes a large software related safety expenditure for a relatively small quantity of really sensitive data. Thus the compliance of the software related rules for the users becomes on one hand often an annoying routine and on the other hand in context to huge data flow represents a source of errors concerning the identification of the sensitive partial amount of data and the appropriate use of the intended preventive measures.

As a complicated and expensive solution also a second PC can be used for the operation with safety-relevant data that is not connected to the internet and/or internal network or further channels of communication.

In connection with the increasing numbers of pro-actively used PC's and pro-active networks, in particular under the aspect of the permanent connection of a PC into a pro-active network, known under the term “always on”, for example over mobile communication channels, a substantial disadvantage consists therein, that unnoticed and unidentified safety leaks may occur at any point of the network. Therewith is created an always growing risk of the data inspection through third party. In this regard the fact is particularly malicious that thereby at any time data transfers can take place which are unnoticed by the authorized PC users. Stationary PC's are exposed to these risks that are connected with an intranet with partial wireless transmission, and all mobile PC's, which are integrated into the wireless communication.

It is an object of the present invention, to allow an increase of the value in use of a PC by an absolutely safe separation of the substantial permanent operating and user data carriers in a user friendly kind, in particular regarding the security of data and regarding the access to the PC.

There shall be provided especially a PC with that it is possible alternatively on one hand the integration into the modern communication, such as internet and/or intranet, as well as on the other hand an absolutely safe mode of operation with confidential data not observable by modern means of communication.

There shall be provided especially a stationary PC with which a new philosophy of the central data storage shall be possible, whereby especially the sensitive data shall be stored centrally on an appropriate subsystem. The decentralized and/or the mobile use of these sensitive data shall be performed through the decentralized operation of the appropriate subsystem at any location of a stationary PC.

There shall be provided especially a mobile PC with which a new philosophy of the centralized data storing shall be possible. Thereby the sensitive data shall be stored centrally on an appropriate subsystem of this mobile PC, whereby the decentralized and/or mobile use of these sensitive data shall be made possible. Such a PC shall also be applicable in a sequential way by a further subsystem together with appropriate networks and further data transmission means and communication means, whereby the separation of the sensitive data of a subsystem with regard to the imperfectly protectable data of the other subsystem is ensured at any time at full extent.

There shall be provided especially a PC in which at least one of the subsystems that enables for a connection to media for data transmission and communication may be set out of operation for a freely selected period. That way detection of the location of the PC shall be prevented while operation of that PC with those subsystems that are not connected in the data communication means and in the means for communication, is still possible.

There shall be provided especially a PC that has a transport lock integrated that can be switched on alternatively and be started and operated for a freely selectable period. Therewith on an appropriate mode of operation a detection of the PC for theft monitoring shall be made possible, for example together with a connection to the global positioning system (GPS) data of a transport vehicle.

There shall be provided especially a PC that is equipped with active and/or passive communication and/or detection devices. These communication and/or detection devices shall have an option to be activated or turned off alternatively directly on the PC or via remote control, for example via wireless. Thus, the PC can be located with appropriate mode of operation.

There shall be provided especially a PC in that the status of the selected subsystem is indicated by a mechanical indicator, for example in the form of a switch or by a partial variation of the shape of the PC, in particular by shifting or rotating a part of the PC. Therefore the user shall receive clear visible and/or touchable verification of the selected subsystem. Therewith the user is reminded permanently regarding sensitivity and data security. This can be described with the terms “wyswyg” (what you see what you get) or “ygwys” (you get what you see).

There shall be provided especially a PC, in which the complete separation of the data that is stored in the individual subsystems is absolutely guaranteed. It shall be possible that appropriate data may not be exchanged from one subsystem to an other subsystem both within an individual PC and in the group of similarly equipped PC's neither via networks nor by via connections within that PC, bus, nor by the individual storage media, for example disks, which have to be inserted into the peripheral data readers and data memory.

There shall be provided especially a PC in that the user has the possibility of operating this PC alternatively as independent single workstation or as a workstation that is embedded into a network or into several networks.

There shall be provided especially a PC that allows alternatively for an interconnection with any of various autonomous networks independent from each other according to their degree of privacy classified and in terms of hardware separated.

There shall be provided especially a PC that prevents any observation of sensitive data via networks under the aspect of the permanent integration of a PC into pro-active networks, known under the term “always on”.

There shall be provided especially a PC, in which the configuration of hardware and the operating status of the respective autonomous network can be visualized and monitored on changes.

There shall be provided especially a PC, in which the operating status of the further PC's, with which the PC is connected to an autonomous network, can be visualized and can be monitored on changes.

There shall be provided especially a PC, in which it is possible to completely view, to further process, to mutate, to store and to delete specific data in individualized and personalized form on various analogue equipped PC's.

There shall be provided especially a PC, in which it is possible, to combine specific data in individualized, personalized and miniaturized form in such a manner, that for their decentralized use only a minimum of transportation effort in a physically safe manner is necessary.

There shall be provided especially a PC that allows for integral data security of sensitive data within one subsystem. Thereby neither a user nor a person that is responsible for the system shall be forced to transfer across a subsystem border a partial amount or the total amount of the existing data in different periods. There shall be provided a new form of backups as autarkic solution within a subsystem, preferably in an automated form. Such backups shall be performed accordingly permanently on site without the need of a person, which is responsible for the system.

There shall be provided especially a mobile PC, which follows a new philosophy of the data storing, so-called backup's, for sensitive data. Thereby on one hand the immediate availability of the actual sensitive data in a redundant form and on the other hand the immediate availability of staggered stored historical data is allowed at any time on site in one and in single mobile PC as an integral solution.

There shall be provided especially a mobile PC that has the new functionalities integrated without the need for substantial additional space and without substantial additional weight.

There shall be provided especially a PC, which allows the physical separation of the data with regard to their sensitivity from the view of the user. Thereby shall be protected against unauthorized access not the total of the existing data but only selected partial amounts of data. This protection shall be correspondingly economical and appropriate.

The equipment and hardware upgrades respectively of an existing PC shall be considerably more economical than the possible investment into a second PC for the same purpose. Thereby all the substantial and expensive components of a PC, for example the core system with the microprocessor (CPU), the main memory and/or working memory of the core system as well as the display, shall be used sequentially several times, or shall be optimized individually for the various requirements of the subsystems.

With the inventive PC these objects are achieved in an economically and user-friendly way under predominant use of conventional hardware, conventional components and conventional software. For this only some components and parts of the well-known hardware and the system architecture must be changed partially and supplemented purposefully.

The inventive personal computer, including its portable versions, like laptops, handhelds, comprising

the necessary peripheral devices, like display, cabinet and means for the data input, and further components,

at least one core system 1a, 1b, 1c, comprising

at least one microprocessor 2, also named central processing unit, CPU, as well as occasionally

at least one BIOS 3a, 3b, 3c, basic input output system, and/or

at least one main memory and/or working memory 4a, 4b, 4c, and/or

at least one intermediate memory 5a, 5b, 5c, also named cache memory, and/or

the appropriate memory management 6a, 6b, 6c, also named memory management unit, MMU, and

at least one subsystem 7a, 7b, 7c, comprising

at least one graphic controller, and/or

at least one SCSI-controller, small computer system interface, and/or

at least one RAID-Controller, redundant array of inexpensive disks,

is characterized in that the personal computer comprises

at least two from each other independent subsystems 8, whereby each present subsystem 8 is based on a separate, independent classification of the data contained in it due to their safety-specific sensitivity, either

for all subsystems 8 a central core system 1a is present, or

for a first partial amount of subsystems 8 a common core system 1b and for any further partial amount of subsystems 8 either an individual core system 1c or at least a further common core system 1b is present, or

for each individual subsystem 8 an individual core system 1c is present,

each subsystem 8 comprises at least one individual physical and/or virtual storage medium 9,

each subsystem 8 comprises at least one individual integrated operating system 10, either

for all present subsystems 8 a central BIOS 3a is present, or

for a first partial amount of subsystems 8 a common BIOS 3b and for any further partial amounts of subsystems 8 either an individual BIOS 3c or at least one further common BIOS 3b is present, or

for each individual subsystem 8 one individual BIOS 3c is present, either

for all present subsystems 8 a central main memory and/or working memory 4a, a central intermediate memory 5a and a central memory management 6a is present, or

for a first partial amount of subsystems 8 a common main memory and/or working memory 4b, a common intermediate memory 5b and a common central memory management 6b and for any further partial amounts of subsystems 8 either an individual main memory and/or working memory 4c, an individual intermediate memory 5c and an individual memory management 6c or at least one further common main and/or working memory 4b, a common intermediate memory 5b and a common memory management 6b is present, or

for each individual subsystem 8 an individual main memory and/or working memory 4c, an individual intermediate memory 5c and an individual memory management 6c is present,

the subsystems 7a, 7b, 7c are contained either in a core system 1a, 1b, 1c or in a subsystem 8 or are arranged between a core system 1a, 1b, 1c and a subsystem 8, whereby either

for all present subsystems 8 at least one central subsystem 7a is present, or

for a first partial amount of subsystems 8 at least one common subsystem 7b and for any further partial amounts of subsystems 8 either at least one individual subsystem 7c or at least one further common subsystem 7b is present, or

for each individual subsystem 8 at least one individual subsystem 7c is present,

the subsystems 8 alternatively may be started either together or independently form each other and may be prepared for operation or may be put into a standby mode,

the subsystems 8 may be started and operated alternatively either commonly or independently form each other,

the subsystems 8 may be put from the operating mode into a standby mode or may be turned off alternatively either commonly or independently form each other,

the subsystems 8 may be turned off from a standby mode alternatively either commonly or independently form each other,

only one single subsystem 8 may be connected, started, operated and be turned off together with the respective necessary peripheral devices and further components of the personal computer as an overall system, whereas during this phase all remaining subsystems 8 are not connected with the overall system, and thus no data transfer from one subsystem 8 to an other subsystem 8 may occur,

whereby for the case A, that in the personal computer is present a central core system 1a, the subsystems 8 are integrated or are directly connected with the personal computer in such a way, that simultaneously in maximum only one subsystem 8 together with the central core system 1a and the necessary subsystems 7a, 7c may be started, operated and be turned off, whereas during this phase the remaining subsystems 8 of this personal computer are not connected with the central core system 1a and may also not be connected with the central core system 1a and are either turned off or are in a standby mode,

whereby for the case B, that in the personal computer are present common and individual core systems 1b, 1c,

B1—the subsystems 8, which are assigned to a common core system 1b, are integrated in such a manner into the personal computer or are directly connected with the personal computer, that simultaneously in maximum only one of these subsystems 8 together with the common core system 1b and the necessary subsystems 7b, 7c may be started, operated and be turned off, whereas during this phase the remaining subsystems 8 of this assignment category are not connected with the common core system 1b and may also not be connected with the common core system 1b, and are either turned off or are in a standby mode,

B2—the subsystems 8, for which an individual core system 1c is present, are integrated in such a manner into the personal computer or are directly connected with the personal computer, that simultaneously in maximum only one of these subsystems 8 may be connected, started, operated and be turned off together with the respective necessary peripheral devices and further components as well as the necessary subsystems 7c of the personal computer as an overall system, whereas during this phase all remaining subsystems 8 are not connected with the overall system and also may not be connected with the overall system,

whereby for the case C, that in the personal computer for each subsystem 8 an individual core system 1c is present, these subsystems 8 are integrated in such a manner into the personal computer or are directly connected with the personal computer, that simultaneously in maximum only one of these subsystems 8 may be connected, started, operated and be turned off together with the necessary peripheral devices and further components as well as the necessary subsystems 7c of the personal computer as an overall system, a so called “hot-swap”, whereas during this phase all remaining subsystems 8 are not-connected with the overall system and also may not be connected with the overall system,

during the change from a subsystem 8 to another subsystem 8 either

the central core system 1a or the common core system 1b as well as the necessary peripheral devices and the further components as well as the necessary subsystems 7a, 7b, 7c of the personal computer as an overall system must be turned off compulsory in such a way, that

on one hand all in the central core system 1a or in the common core system 1b as well as in the necessary subsystems 7a, 7b, 7c stored data neither are buffered nor are in any way supported and are completely deleted within the time interval for starting another subsystem 8 or within the time interval for the connection admission with a subsystem 8 which is in a standby mode, and/or before the complete deletion of the data for their preservation on the previously operated subsystem 8, and

on the other hand all for the repeated starting of the central core systems 1a or of the common core system 1b and for the following initial start-up, the so-called booting, of the newly selected subsystem 8 necessary primary initialization data, including the BIOS data and configuration data, on the central core system 1a or on the common core system 1b or the respective subsystem 8 remain unchanged and are connected together with the central core system 1a or the common core system 1b of the specific hardware configuration of the newly selected subsystem 8, or

the respective individual core system 1c together with the respective subsystem 8 is separated in such a way form the overall system of the personal computer as well as the necessary subsystems 7c, that all in the respective peripheral devices and further components as well as in the required subsystems 7c of the overall system of the personal computer stored data are neither buffered nor are in any way supported and are completely deleted within the time interval for starting another subsystem 8 or within the time interval for the connection admission with a subsystem 8 which is in a standby mode, and/or before the complete deletion of the data for their preservation on the previously operated subsystem 8.

Preferred embodiments of this invention are defined in the dependent claims.

In the following part are described possible embodiments of the present invention.

Thereby embodiments, as they are defined in the dependent claims, are usually not repeated.

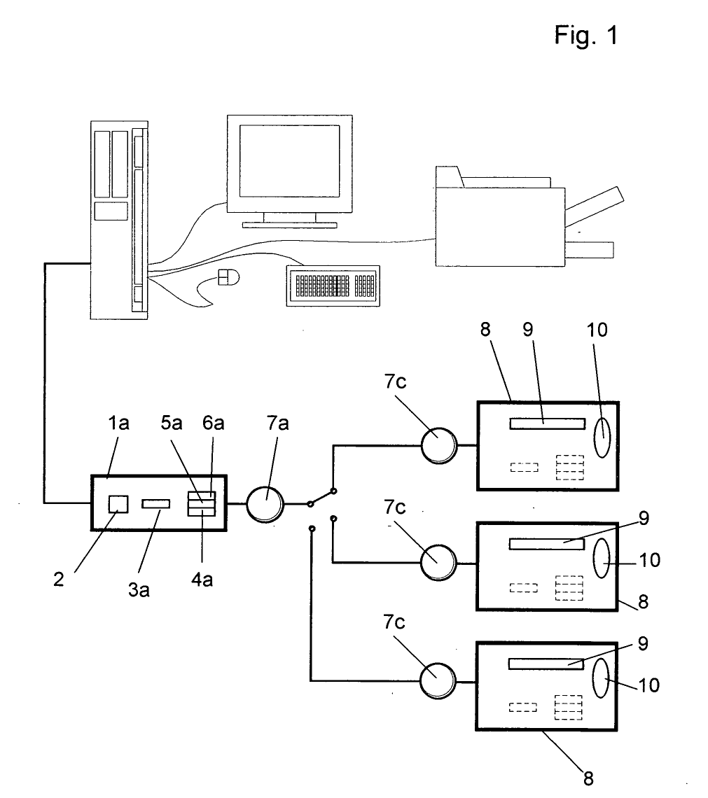

In the FIGS. 1, 2 and 3 are schematically shown besides of a cabinet the usual peripheral devices, that is a display, a keyboard, a computer mouse and a printer.

In the FIGS. 1, 2 and 3 are shown as central elements the BIOS 3a, the main memory and/or working memory 4a, the intermediate memory 5a and the memory management 6a. The corresponding versions 3c, 4c, 5c and 6c of these elements are shown in the individual subsystems 8 only schematically with broken lines.

FIG. 1 only schematically shows a possible embodiment of an overall system, in which a central core system 1a is present, which is connected with one of the three possible subsystems 8.

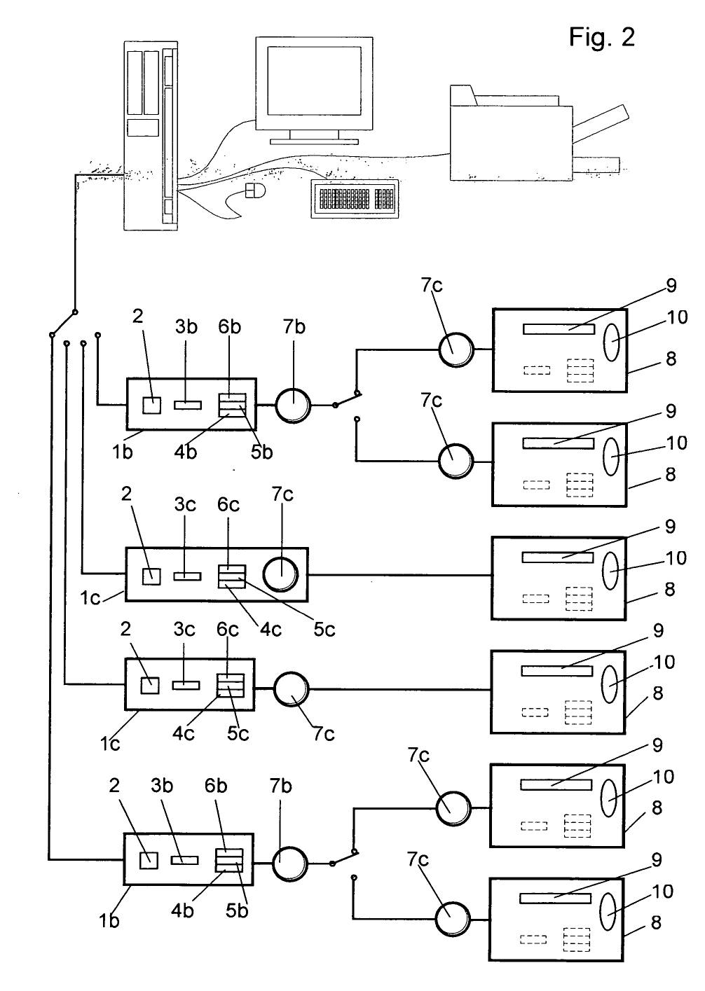

FIG. 2 only schematically shows a possible embodiment of an overall system, in which are present two common core systems 1b, which each are connected with one of two possible subsystems 8, and two individual core systems 1c, which each are connected with a subsystem 8.

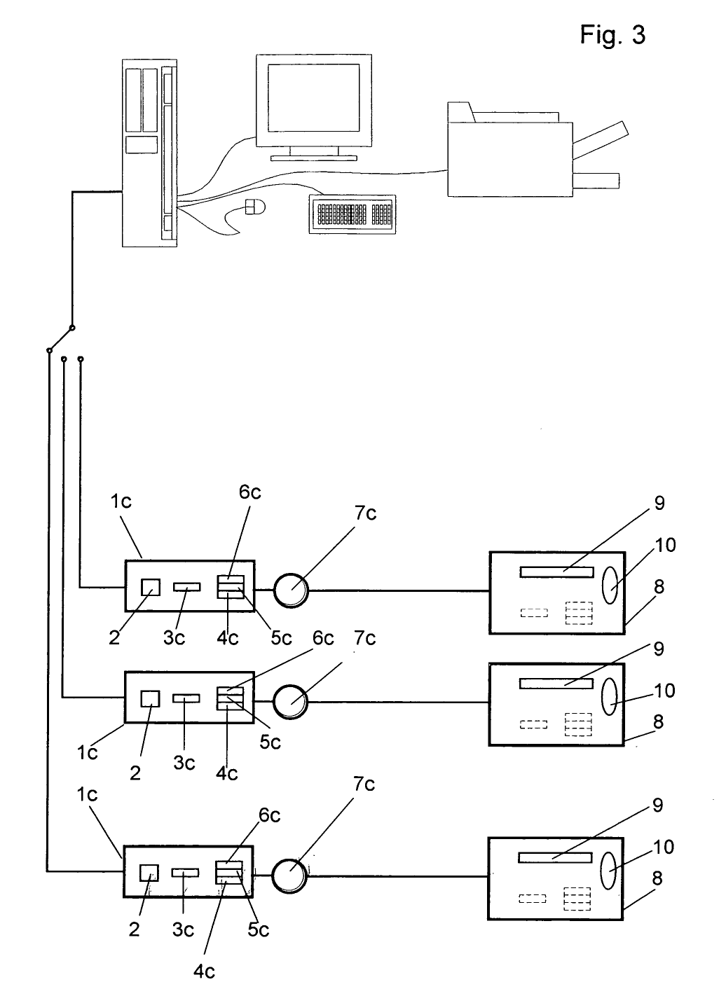

FIG. 3 only schematically shows a possible embodiment of an overall system, in which are present three individual core systems 1c, which each are connected with a subsystem 8.

The inventive PC is equipped in such a manner that the user must determine consciously one single subsystem 8 and then only this subsystem 8 may be connected and operated together with the necessary peripheral devices and further components, of which the personal computer consists, as an overall system. It is impossible that the PC itself or a third party can determine a subsystem 8 in the PC and operate it together with said elements by an indirect access to the PC, for example over a network.

For the prevention of a data exchange between individual subsystems 8 the PC according to the present invention is preferably equipped in such a manner that all data that is contained in all volatile memories of the PC and/or in the involved peripheral devices, will be deleted completely before the add-on connection of an other subsystem 8, whereby this deletion is effected depending upon the used memory components either by a previously defined period of the voltage-free condition of these memory components or by a so-called active deletion of volatile data memories, for example CMOS, which take an indifferent memory status during an power outage.

With a PC according to the present invention both the choice of a subsystem 8 and the connection of the selected subsystem 8 with said elements and the possible interconnection into a network is performed on the basis of the hardware and their allocation in well defined physical, self-sustained positions.

With a PC according to the present invention the switching elements are preferably designed in such a way that they have well defined physical switching positions. Self-holding switching positions are preferred. They can be in a locking form or in the form of an electrical or optical switch, for example an opto coupling device. In contrary to electrical switches an opto coupling device does not produce voltage peaks during its operation. This is in particular important for the switching of bus connections.

With a PC according to the present invention it is possible that the selected subsystem 8 respectively the thereby selected mode of operation is obvious or touchable for the user at any time either at the switching element or by the actuator or by a partial variation of the shape of the PC, in particular by shifting or turning of a part of the PC. In corresponding embodiment it is also possible to show these information's additionally on a display. A further indication may also be given on appropriate peripheral devices. This can be done for example in the form of a marked light, in the form of several marked lights or in the form of a set of lights, which is mounted on the keyboard, on a computer mouse, on the cabinet of the PC or on the cabinet of the display. Additionally the kind and/or the layout of the software installed on the different subsystems 8 can also be differentiated consciously, for example by the use of different operating systems 10, such as Windows or Linux, and their user programs. Also the configuration of homogeneous software can be varied purposefully. So for example the background colors of the respective software can be different on the display. In addition any combination of the above mentioned measures may be carried out.

In an inventive PC it is also possible that besides of the selected subsystem 8, respectively the mode of operation selected thereby, also its interconnection into a network is obvious or touchable for the user at any time at the switching element or at the actuator or by a partial variation of the shape of the PC, in particular by shifting or turning of a part of the PC. In a corresponding embodiment this information may additionally also be indicated on a display. Especially additional information may also be indicated by a monitoring system, both by the operating modes of the subsystems 8 as contained in the PC, and by the operating modes of the further subsystems 8, which are indirectly connected by networks with the PC, for example on a display.

Additionally a complete visualization of the network configurations and of the respective subsystems 8 on this monitoring system is possible what allows for a permanent monitoring of the actual network configuration and warnings upon change.

With a PC according to the present invention is also given the possibility, that all data with respect to their sensitivity over all uses, including their application, their storing and their transport, may be separated consequently, continuously, completely and permanently. This allows both an economical protection of the respective partial amounts of data with regard to unauthorized access or inspection and a corresponding simple and clear identification of such data for the user. As a result thereof also a corresponding risk-conscious handling of the data for the plurality of the respective users is possible. With an inventive PC is given herewith especially the possibility to achieve these protections in particular by physical, visible and in itself stable differentiations, what allows for the user in regard to the invisible and timely indifferent software solutions at any time a complete orientation, both with regard to the actual mode of the PC and the sensitivity of the associated data.

With these measures a new safety standard for the orientation of a user is reached.

According to a first possible embodiment the PC is equipped with two hard disks 9, which are mounted into the PC cabinet. Besides of these two hard disks 9 no further hard disks are installed into this PC or are connected with this PC.

The hard disks 9 with the respective operating systems 10 are installed in a fixed manner for the two modes of operation “open” and “safe” in such a way, that an individual initial start-up of the respective subsystem 8 is performed directly by a switching element, which is present in this embodiment as rotary switch and is designed as actuator and is located at the front side of the PC.

The switching element is designed in the form of a multipolar rotary switch with 4 inputs on 3 outputs each, and that is switchable short-circuiting. The three self-holding switching positions of the rotary switch are marked on its front with “safe”, “off” and “open”.

With the mode of operation “safe” the connections to the internet and the relevant hardware components that are necessary for the setting-up, such as modem, network interface cards, are interrupted physically by the switching element together with the connection with the corresponding subsystem 8 “open”, so that an access from the internet to the corresponding hard disk 9 under the mode of operation “safe” is absolutely excluded.

Additionally in the mode of operation “safe” the operating system 10 is installed on the corresponding hard disk 9 in such a way, that the network functions cannot be selected and cannot be operated, in that for example specific programs and drivers are not installed, which results in a redundant security against an unintentional connecting admission with the internet. By interruptions in the hardware and occasionally resulting error messages, which have to be confirmed by the user, the user can also be notified upon its access to the sensitive subsystem 8 or one of the sensitive subsystems 8.

Furthermore, an essential element consists therein, that while switching from one mode of operation to the other mode of operation the core system 1a and if necessary further components of the personal computer must be switched off obligatorily, what is given by the switching positions “on”, “off”, “on”.

By the obligatory switching off of the core system 1a and if necessary of further components of the personal computer all user data is deleted as contained in the working memory and intermediate memory 4a, 5a respectively. The necessary specific system data, including the BIOS data, remains in an unchanged form.

For the operation of the personal computer exclusively one of the two hard disks 9, which is allocated to the respective subsystem 8 “safe” or “open”, is connected by the switching element in the corresponding position with the core system 1a of the PC.

In a first application the PC is started and is operated in the mode of operation “safe”. As a rule, after having used the PC the operation of the PC will be terminated by running down the operating system 10, preferably a regular run down of the operating system 10. With unintentional interruption of the operation, for example by a power cut, the operating system 10 has then to be checked with regard to an ordinary function and if necessary it has to be repaired by an internal test program, scandisk.

For a following further operation it is necessary to change from the mode of operation “safe” to the mode of operation “open” as well as a running down of the operating system 10, preferably a regular run down of the operating system 10.

By the turn of the rotary switch from the position “safe” to the position “open” over the intermediate position “off” the core system 1a is thereby booted with a reset.

Subsequently, the personal computer is started together with the newly selected subsystem 8. The change of the hardware configuration of the PC is recognized by its BIOS 3a during the start-up, in that the absence of the former hard disk, known to the BIOS, is recognized by the BIOS 3a and is shown in the form of an error message “primary master hard disk fail” on the display. Subsequently, over manual calling of the “BIOS Setup” the newly present hardware configuration of the PC is determined, and the BIOS-data are manually changed by appropriate inputs in agreement with the newly found PC hardware configuration, as described in detail in the following part, and is stored afterwards for the start-up of the PC in the new configuration:

Depending on the manufacturer and version of the BIOS specific individual inputs over the keyboard and/or the mouse at the respective PC are necessary to be done for its change. The following data refer to a possible embodiment of a PC, which is equipped with one

ROM PCI/ISA BIOS

CMOS SETUP UTILITY

AWARD SOFTWARE INC.

as well as with 2 “IDE” hard disks 9.

After the appearance of the above mentioned error message the following inputs are performed:

By pressing the key “delete” the “BIOS Setup” of the PC is called, and the menu “IDE HDD AUTO DETECTION” is selected on the keyboard and is then started by pressing the key “enter”.

In the following the step “Auto Detecting” runs for the in maximum four by the BIOS 3a manageable and correspondingly denoted hard disk drives, HDD, and the search result of the HDD 9 found by the BIOS 3a in the PC becomes indicated in individual steps in the form of the recognized new hard disks 9 (respectively also in the form of not or no longer installed HDD 9) on the display in the following sequence to the selection:

| | | |
|---|---|---|
| Select Primary Master | [symbol] | Indication 0 |
| Select Primary Slave | [symbol] | Indication 0 |
| Select Secondary Master | [symbol] | Indication 0 |
| Select Secondary Slave | [symbol] | Indication of the HD- |
| | | data. |

These indications are selected individually in each case as option over the keyboard and confirmed by input of “Y” (yes) and are executed by the following pressing of the key “Enter”. Therewith the next inquiry in the program sequence is started and indicated.

Finally the menu option “save and EXIT SETUP” is selected, confirmed by the input of “Y” (Yes) and implemented and terminated with the instruction “Enter”.

Since during the “BIOS Setup” the German keyboard driver is not active, the system proceeds from an English keyboard, in which Y is to be operated via the key Z of the German keyboard.

Subsequently, the operating system 10 will be searched by the “BIOS” 3a on the now known and thus accessible hard disk 9, the operating system 10 is recognized as such and is started. By the successful setup of the appropriate contact over the rotary switch, the modem will be connected with the PC. The modem is recognized over the operating system 10, and thus afterwards the internet connection becomes possible.

In contrary to the mode of operation “safe” in the operation mode “open” the therefore necessary software, for example specific programs and drivers, is installed on the corresponding hard disk 9.

If the boot process of the PC is done in the same configuration as it was previously operated and switched off, usually no further action is required.

For the change from the mode of operation “open” to the mode of operation “safe” the corresponding error message “secondary slave hard disk fail” appears during the start-up in the new configuration “safe” of the PC, and accordingly the result of the step “Auto-Detecting” reads differently according to the newly found hardware configuration of the PC and results in the following search result:

| | | |
|---|---|---|
| Select Primary Master | [symbol] | Indication of the HD- |
| | | data |
| Select Primary Slave | [symbol] | Indication 0 |
| Select Secondary Master | [symbol] | Indication 0 |
| Select Secondary Slave | [symbol] | Indication 0. |

These indications are selected individually in each case as option on the keyboard and confirmed by input of “Y” (yes) and are executed by the following pressing of the key “Enter”. Therewith the next inquiry in the program sequence is started and indicated.

Only in the mode of operation “safe” with each start-up acknowledgement and confirmation is necessary of the error message of the “hardware assistant” of the operating system 10 concerning missing driver software for the network interface card, whereby this acknowledgement can be done either by pressing of the key “Esc” or by clicking the icon “cancel” with the mouse in the field of the error message. This necessary manipulation draws the attention of the user again to the startup of the mode of operation “safe”.

Only with the change from one mode of operation to an other mode of operation the above mentioned actions have to be taken regarding the adjustment of the BIOS-data according to the hard disk 9, as selected by the rotary switch.

According to a second possible embodiment the PC contains four subsystems 8 and is equipped with an appropriate multipolar switching element. The first subsystem “safe” contains three HDD, wherefrom two HDD are used permanently for the mirroring of the programs and data, and wherefrom the third HDD is used permanently to ensure the incremental backups. For each of the further three subsystems “work”, “internal” and “open” is used an HDD 9. The backup of these three subsystems 8 is performed by the appropriate networks, for example by using backup-servers.

According to a third possible embodiment the PC contains four subsystems 8 and is equipped with an appropriate multipolar switching element. The first subsystem “safe” contains three HDD, wherefrom two HDD are used permanently for the mirroring of the programs and data, and wherefrom the third HDD is used permanently to ensure the incremental backups. Thereby the three HDD of the first subsystem “safe” are combined in the form of a physical removable carrier. Thus an additional protection for the subsystem “safe” is made possible, in that the physical removable carrier may be stored during the time it is not used in a treasury, and is protected in this way from theft and fire. For each of the further three subsystems “work”, “internal” and “open” is used a HDD 9. The backup of these three subsystems 8 is performed by the appropriate networks, for example by using backup-servers, which are specific for each subsystem 8.

According to a further possible embodiment of a personal computer the switching element is actuated indirectly. An indirect actuation of the switching element can be done for example by an electrical way, whereby the selection of the desired mode of operation is done by an actuator, such as a rotary switch, a slide switch, a toggle switch, or a key switch, which is dislocated from the switching element.

Both for the direct and for the indirect actuation of the switching element either the switching element or the appropriate actuator is preferably designed as a rotary switch or as a key switch and is located at such a position, which is suitable for the access and the operation and is well visible, for example at the front side of the PC.

The key switch can be designed in such a manner that the corresponding key before the selection of the mode of operation “safe” must be inserted compulsory and must remain inserted and may not be removed during the time, in which the mode of operation “safe” is in use.

In a further possible version the key may only be pulled out and removed in the nearest located switching position “off”.

The other switching positions, as for example “internal” and/or “open”, can be designed in such a manner that they can be selected alternatively with the same key or with another key or without any key.

The key can be designed as both a sole mechanical element and a mechanical/electrical element, including any combination thereof, for example in the form of a permutation lock.

Also an active or passive, electrical and/or electronic key is applicable, for example in the form of “badges” or in the form of specific software with password access, in particular also in the form of BIOS-passwords, or also based on biometric methods in the form of personal characteristics, like finger prints, eye characteristics, etc., recognizing devices.

Inventive personal computers alternatively may be operated both as single workstation and in connection with networks. According to the specific requirements with regard to the data security both the single subsystems 8 and the corresponding autarkic designed networks may be made accessible to a selected group of users.

Inventive personal computers allow for decentralized use of data, in particular of sensitive data. Thereby no data transfer must be performed by external networks. The corresponding subsystem 8 remains either with the respective user or is given to the entitled third party and is operated in a decentralized manner by these persons by means of a correspondingly equipped personal computer.

An inventive PC has at least two from each other independent subsystems 8. Due to this measure it is possible to operate the PC alternatively sequentially and facultatively in at least one subsystem 8 or in the presence of a larger number of subsystems 8 also in several from each other independent networks.

When inventive personal computers are connected within a network or in several networks, then these networks are designed in such a manner, that only the equivalent subsystems 8, as contained in the individual PC's, can be connected, operated and switched off, thus for example in the respective modes of operation “work” with “work”, “internal” with “internal”, “open” with “open”.

A favorable version of such networks can consist therein, that the security is also guaranteed by the special design of the network connections in relation to access by third party to the individual subsystems 8, for example by prevention of possible safety leaks in the network design, in particular by explicitly not using latent or potentially open communication ways, such as telephone, wireless, wireless beam, gateways, routers, etc.

When inventive PC's are connected via a network or within several networks these networks are preferably built in such a manner that they are consciously incompatible, for example by using different categories of data communication media, for example unshielded twisted pair-cable, UTP-cable, coaxial cable, optical fiber cable, or by different among themselves not compatible versions of autarkic designed networks belonging to the same category, for example by different geometrical shapes of the transmission-links and connecting-links, for example the plug connections.

It is also possible to differentiate from each other the individual networks by using or use of special naming. The individual connections can be protected if necessary also by additional actions such as installation in separate pipings or by further constructional measures. Besides of such according to their degree of the privacy classified, consciously small and therefore monitored autonomous networks, in comparison to a single large internal network, have a higher safety level.

When in an inventive PC at least one of the subsystems 8 is designed in such a manner, that this subsystem or these subsystems 8 are in the form of a physically removable carrier then there exists the possibility to use the PC in an individualized or personalized form. Due to this physical removable carrier it is possible to bring to operation and to operate such individualized or personalized data both in a stationary and in a mobile inventive PC at any place, for example in the form of “mobile offices”. Thereby the access to the individualized or personalized data is performed locally on an inventive PC and not by means of network connections that are connected to safety risks and are accessible from the view of the user often undefined user groups, for example via intranet or internet.

By the use of such physical removable carriers and/or by the use of storage sub modules the possibility exists to give to a PC a new functional design with new integrated functionalities and/or a new architecture.

As subsystems 8 also removable data media may be used, for example in the form of mobile HDD's or in the form of “PC-Cards” (PCMCIA-Cards).

In an inventive PC at least one of the subsystems 8 together with the peripheral data readers and data memory devices, assigned to it, can be designed in such a manner, that for the prevention of unintentional data exchange from a first subsystem 8 to any further subsystem 8, the individual storage media to be introduced temporarily into said peripheral data readers and data memory that are designed among themselves to be incompatible. Therewith is defined an additional safety circuit for the administration of data and for the handling of data outside an inventive PC.

In an inventive PC at least one of the subsystems 8, preferably the subsystem “safe”, can be equipped in such a manner, that for the prevention of data transfers beyond a subsystem border during so-called “Backups” for the data saving the corresponding subsystem 8 is equipped with two HDD 9, and a synchronous data storage on the two HDD 9 in the form of a so-called “mirroring” is effected, so that in the case of a failure of one of the two HDD's an absolute redundancy of the actual data and of the programs is available on the second HDD.

An inventive PC may be equipped with an integral module, which besides of the storage media 9 contains also a switching element. This integral module can have the form of future generations of hard disks or of bootable optical memory. This integral module may be designed in such a manner, that several individual storage media 9 are arranged together in a single cabinet of conventional dimension, which served in former times for the assembling of a single storage medium. With this measure the possibility is given for a further miniaturization. This allows among others for various storage media 9 being integrated later into a conventional PC even under poor conditions regarding space.

Conventional PC's can be upgraded or extended with correspondingly preassembled upgrading kits.

Such a kit for upgrading of existing personal computers for the achievement of the extended functionality of the personal computers, preferably for their stationary embodiments, according to the present invention, can comprise at least one switching element, which is equipped with the correspondingly configured cables and plugs for the simple setup of the connections between “main board” and the hard disks as well as the occasionally needed interfaces, transmission cards, I/O cards and actuators, if necessary in combination with additional storage media 9, for example hard disk drives, HDD, as well as the further occasionally needed elements, for example integrated or adaptive interface managements and network managements.

Such a kit for upgrading of existing personal computers for the achievement of the extended functionality of personal computers, preferably for their mobile embodiments, for example laptops, handhelds, according to the present invention, can have the form of a pre-assembled cabinet, which comprises a switching element and its cabeling as well as pre-assembled modules, and the occasionally needed additional components in the form of at least one hard disk, as well as the further occasionally needed elements, for example integrated or adaptive interface managements and network managements.

Such a kit for upgrading of existing personal computers for the achievement of the extended functionality of personal computers according to the present invention can comprise at least two autonomous storage media 9 in the form of at least one integral module,

whereby in this module is integrated preferably the switching element, and whereby this kit comprises occasionally further needed additional components,

for example correspondingly preassembled cables and plugs for the setup of the connections between the integral module and the “main board”, as well as correspondingly preassembled cables and plugs for the setup of the connections to the occasionally needed interfaces, transmission cards, I/O cards and actuators.

In the present invention the following reference numerals are used:

1a central core system

1b common core system

1c individual core system

2 microprocessor

3a central BIOS

3b common BIOS

3c individual BIOS

4a central main memory and/or working memory

4b common main memory and/or working memory

4c individual main memory and/or working memory

5a central intermediate memory

5b common intermediate memory

5c individual intermediate memory

6a central memory management

6b common memory management

6c individual memory management

7a central subsystem

7b common subsystem

7c individual subsystem

8 subsystem

9 storage medium (in the subsystem)

10 operating system (in the subsystem).

1. A personal computer, including its portable versions, like laptops, handhelds, comprising
the necessary peripheral devices, like display, cabinet and means for the data input, and further components,
at least one core system (1a, 1b, 1c), comprising
at least one microprocessor (2), also named central processing unit, CPU, as well as occasionally
at least one BIOS (3a, 3b, 3c), basic input output system, and/or
at least one main memory and/or working memory (4a, 4b, 4c), and/or
at least one intermediate memory (5a, 5b, 5c), also named cache memory, and/or
the appropriate memory management (6a, 6b, 6c), also named memory management unit, MMU, and
at least one subsystem (7a, 7b, 7c), comprising
at least one graphic controller, and/or
at least one SCSI-controller, small computer system interface, and/or
at least one RAID-Controller, redundant array of inexpensive disks,
characterized in that the personal computer comprises
at least two from each other independent subsystems (8), whereby each present subsystem (8) is based on a separate, independent classification of the data contained in it due to their safety-specific sensitivity, either
for all subsystems (8) a central core system (1a) is present, or
for a first partial amount of subsystems (8) a common core system (1b) and for any further partial amount of subsystems (8) either an individual core system (1c) or at least a further common core system (1b) is present, or
for each individual subsystem (8) an individual core system (1c) is present,
each subsystem (8) comprises at least one individual physical and/or virtual storage medium (9),
each subsystem (8) comprises at least one individual integrated operating system (10), either
for all present subsystems (8) a central BIOS (3a) is present, or
for a first partial amount of subsystems (8) a common BIOS (3b) and for any further partial amounts of subsystems (8) either an individual BIOS (3c) or at least one further common BIOS (3b) is present, or
for each individual subsystem (8) one individual BIOS (3c) is present, either
for all present subsystems (8) a central main memory and/or working memory (4a), a central intermediate memory (5a) and a central memory management (6a) is present, or
for a first partial amount of subsystems (8) a common main memory and/or working memory (4b), a common intermediate memory (5b) and a common central memory management (6b) and for any further partial amounts of subsystems (8) either an individual main memory and/or working memory (4c), an individual intermediate memory (5c) and an individual memory management (6c) or at least one further common main and/or working memory (4b), a common intermediate memory (5b) and a common memory management (6b) is present, or
for each individual subsystem (8) an individual main memory and/or working memory (4c), an individual intermediate memory (5c) and an individual memory management (6c) is present,
the subsystems (7a, 7b, 7c) are contained either in a core system (1a, 1b, 1c) or in a subsystem (8) or are arranged between a core system (1a, 1b, 1c) and a subsystem (8), whereby either
for all present subsystems (8) at least one central subsystem (7a) is present, or
for a first partial amount of subsystems (8) at least one common subsystem (7b) and for any further partial amounts of subsystems (8) either at least one individual subsystem (7c) or at least one further common subsystem (7b) is present, or
for each individual subsystem (8) at least one individual subsystem (7c) is present,
the subsystems (8) alternatively may be started either together or independently form each other and may be prepared for operation or may be put into a standby mode,
the subsystems (8) may be started and operated alternatively either commonly or independently form each other,
the subsystems (8) may be put from the operating mode into a standby mode or may be turned off alternatively either commonly or independently form each other,
the subsystems (8) may be turned off from a standby mode alternatively either commonly or independently form each other,
only one single subsystem (8) may be connected, started, operated and be turned off together with the respective necessary peripheral devices and further components of the personal computer as an overall system, whereas during this phase all remaining subsystems (8) are not connected with the overall system, and thus no data transfer from one subsystem (8) to an other subsystem (8) may occur,
whereby for the case A, that in the personal computer is present a central core system (1a), the subsystems (8) are integrated or are directly connected with the personal computer in such a way, that simultaneously in maximum only one subsystem (8) together with the central core system (1a) and the necessary subsystems (7a, 7c) may be started, operated and be turned off, whereas during this phase the remaining subsystems (8) of this personal computer are not connected with the central core system (1a) and may also not be connected with the central core system (1a) and are either turned off or are in a standby mode,
whereby for the case B, that in the personal computer are present common and individual core systems (1b, 1c),
B1—the subsystems (8), which are assigned to a common core system (1b), are integrated in such a manner into the personal computer or are directly connected with the personal computer, that simultaneously in maximum only one of these subsystems (8) together with the common core system (1b) and the necessary subsystems (7b, 7c) may be started, operated and be turned off, whereas during this phase the remaining subsystems (8) of this assignment category are not connected with the common core system (1b) and may also not be connected with the common core system (1b), and are either turned off or are in a standby mode,
B2—the subsystems (8), for which an individual core system (1c) is present, are integrated in such a manner into the personal computer or are directly connected with the personal computer, that simultaneously in maximum only one of these subsystems (8) may be connected, started, operated and be turned off together with the respective necessary peripheral devices and further components as well as the necessary subsystems (7c) of the personal computer as an overall system, whereas during this phase all remaining subsystems (8) are not connected with the overall system and also may not be connected with the overall system,
whereby for the case C, that in the personal computer for each subsystem (8) an individual core system (1c) is present, these subsystems (8) are integrated in such a manner into the personal computer or are directly connected with the personal computer, that simultaneously in maximum only one of these subsystems (8) may be connected, started, operated and be turned off together with the necessary peripheral devices and further components as well as the necessary subsystems (7c) of the personal computer as an overall system, a so called “hot-swap”, whereas during this phase all remaining subsystems (8) are not connected with the overall system and also may not be connected with the overall system,
during the change from a subsystem (8) to another subsystem (8) either
the central core system (1a) or the common core system (1b) as well as the necessary peripheral devices and the further components as well as the necessary subsystems (7a, 7b, 7c) of the personal computer as an overall system must be turned off compulsory in such a way, that
on one hand all in the central core system (1a) or in the common core system (1b) as well as in the necessary subsystems (7a, 7b, 7c) stored data neither are buffered nor are in any way supported and are completely deleted within the time interval for starting another subsystem (8) or within the time interval for the connection admission with a subsystem (8) which is in a standby mode, and/or before the complete deletion of the data for their preservation on the previously operated subsystem (8), and
on the other hand all for the repeated starting of the central core systems (1a) or of the common core system (1b) and for the following initial start-up, the so-called booting, of the newly selected subsystem (8) necessary primary initialization data, including the BIOS data and configuration data, on the central core system (1a) or on the common core system (1b) or the respective subsystem (8) remain unchanged and are connected together with the central core system (1a) or the common core system (1b) of the specific hardware configuration of the newly selected subsystem (8), or
the respective individual core system (1c) together with the respective subsystem (8) is separated in such a way form the overall system of the personal computer as well as the necessary subsystems (7c), that all in the respective peripheral devices and further components as well as in the required subsystems (7c) of the overall system of the personal computer stored data are neither buffered nor are in any way supported and are completely deleted within the time interval for starting another subsystem (8) or within the time interval for the connection admission with a subsystem (8) which is in a standby mode, and/or before the complete deletion of the data for their preservation on the previously operated subsystem (8).

2. Personal computer according to claim 1, characterized in that at least one of the present subsystems (8) is in the form of an explicitly autarkic, autonomous subsystem (8), which is completely and permanently separated from all external and internal network data streams and is exclusively denoted for the operation with safety-relevant data, the so-called mode of operation “safe”, which actually in relation to data communication media, for example wireless, networks, in particular external networks, Wide Area network, WAN, internal networks, local Area network, LAN, connections within the computer, bus, is separated or is separately led, respectively, and thus during its operation together with the respective core system (1a, 1b, 1c) and the overall system of the computer corresponds with regard to the data security to a completely isolated “stand alone” personal computer.

3. Personal computer according to one of the claims 1 to 2, characterized in that the layout of the core systems (1a, 1b, 1c) with regard to the architecture, performance of the processors and memory elements is individually adjusted to the respective needs of the different subsystems (8).

4. Personal computer according to one of the claims 1 to 3, characterized in that for the change from a first subsystem (8) to any further subsystem (8)
the previous completely operated first subsystem (8) is either completely turned off or is kept in standby mode by a standby unit, which is contained in the first subsystem (8), in a reduced mode of operation,
the respective operating modes of the individual subsystems (8) are indicated at the personal computer or at a display connected with the personal computer, and that
either before the complete switch-off of the personal computer together with the regularly operated subsystem (8) also the individual subsystems (8) that are still in a standby mode are regularly run down,
or that the personal computer is only partially turned off in such a way that a previous determined number of subsystems (8) is either put into a standby mode or is further kept in the standby mode.

5. Personal computer according to one of the claims 1 to 4, characterized in that all or a partial amount of the subsystems (8), which are not connected with the central core system (1a) or a common core system (1b) are managed by a separate subsystem management in such a way that these subsystems (8)
on occasion of switching on the personal computer are started autonomously and are put into a condition prepared as far as possible and are started up in such a manner that these subsystems (8) are quickly available upon their selection, and whereby an option for pre selection, default, for the following operation of an occasionally pre-determined user program this user program is preferably also prepared and thus is also ready for immediate use, and that
either before the complete turn off of the personal computer besides of the regularly operated subsystem (8) also the individual subsystems (8), which are still in the standby mode, including the respective user programs, are regularly run down,
or that the personal computer is only in such a manner partly switched off that a previously determined number of subsystems (8) with the appropriate network connections through the said subsystem management either is put into a standby mode or is still left in the standby mode,
whereby the time, which is needed by the subsystem management, in order to regularly run down the subsystems (8) with their operating systems (10) and user programs is shorter, than the time, which passes from the command to the complete or partial switch off of the personal computer, and that this delay effect is realized either by means of an appropriate control element, for example a time relay, or by the use of the corresponding signals of the respective operating system (10).

6. Personal computer according to one of the claims 1 to 5, characterized in that at least one core system (1a, 1b, 1c) together with further components, for example the sockets for I/O cards, are contained in an assembling module, in particular in a main board.

7. Personal computer according to one of the claims 1 to 6, characterized in that the subsystems (8) are integrated in such a manner into the personal computer or are directly connected with the personal computer that at the same time in maximum only one subsystem (8) may be started, operated and be turned off, whereas the remaining subsystems 8 are switched off and remain switched off.

8. Personal computer according to one of the claims 1 to 7, characterized in that either
at least one of the subsystems (8) is physically installed and integrated in the personal computer, or
at least one of the subsystems (8) is permanently or temporarily connected with the personal computer, for example over a plug connection or over a cable.

9. Personal computer according to one of the claims 1 to 8, characterized in that at least one of the subsystems (8) is integrated into the personal computer in such a manner, that this subsystem or these subsystems (8) are physically enclosed into a removable carrier, preferably in an individualized or personalized form, that a simple replacement of this physically removable carrier is ensured.

10. Personal computer according to claim 9, characterized in that in the presence of several physical removable carriers a permanent differentiation of the total amount or a partial amount of these physical removable carriers is ensured, preferably in the form of mutual physical incompatibility, for example by different geometrical shapes.

11. Personal computer according to one of the claims 9 to 10, characterized in that for bringing a physical removable carrier into the personal computer or for the removal of a physical removable carrier from the personal computer the use of a key is necessary, whereby this key is preferably designed as mechanical, electrical, electronic, piezoelectric, optical, acoustic or magnetic, active or passive element, including any combination thereof.

12. Personal computer according to one of the claims 1 to 11, characterized in that at least one of the storage media (9) contained in a subsystem (8) is designed in such a manner that this storage medium (9) in the form of an physically enclosed memory unit, preferably in an individualized or personalized form, is designed and arranged in the personal computer in such a manner as a storage sub module, that a simple replacement of this storage sub module is ensured.

13. Personal computer according to claim 12, characterized in that in the presence of several storage sub modules a permanent differentiation of the total amount or a partial amount of these storage sub modules is guaranteed, preferably in the form of mutual physical incompatibility, for example by different geometrical shapes.

14. Personal computer according to one of the claims 12 to 13, characterized in that for bringing a storage sub module into the personal computer or for the removal of a storage sub module from the personal computer the use of a key is necessary, whereby this key is preferably designed as mechanical, electrical, electronic, piezoelectric, optical, acoustic or magnetic, active or passive element, including any combination thereof.

15. Personal computer according to one of the claims 1 to 14, characterized in that the storage medium (9) is a permanent storage medium, preferably a bootable storage medium, for example in the form of a hard disk.

16. Personal computer according to one of the claims 1 to 15, characterized in that in at least one of the subsystems (8) an additional standby unit is present, that supports the operating systems (10) and the user programs that are present in this subsystem (8) for the duration of the standby mode, whereby this additional standby unit is assigned preferably to one of the storage media (9).

17. Personal computer according to one of the claims 1 to 16, characterized in that at least two, in particular three or four, autonomously usable storage media (9) are taken together into an enclosed integral module, whereby this integral module contains for each present storage medium (9) the separate internal control elements, for example of hard disk controllers, and has for each present storage medium (9) the interfaces necessary for its operation, for example electrical connections for the power supply and plug connections for data communication.

18. Personal computer according to one of the claims 1 to 17, characterized in that either all or any partial amount of the connections, that serve for the data transfer from a core system (1a, 1b, 1c) to the subsystems (8), contained in the personal computer, and to the subsystems (8), connected directly with the personal computer, and to further peripheral data readers and data memory devices contained in the personal computer or directly connected with it, are conducted across at least one switching element, for example over
a switching element contained in the personal computer, or
a switching element contained in the core system (1a, 1b, 1c), or
a switching element contained in at least one physical removable carrier,
a switching element directly connected with the personal computer,
a switching element that is contained in an integral module of autonomously usable storage media (9),
including any combination there of.

19. Personal computer according to claim 18, characterized in that the switching element together with the appropriate switching positions and the necessary connections is arranged in a so-called unit, and that the selected mode of operation is shown visually on this unit and/or is shown visually at a display connected with the personal computer, whereby this unit is integrated either in the personal computer or in one of its peripheral devices, for example printer, keyboard, display, or is represented in the form of a so-called “stand alone” device, and is directly connected to the personal computer by cabeling.

20. Personal computer according to one of the claims 1 to 19, characterized in that both the change from a first subsystem (8) to any further subsystem (8) and the necessary complete switch off of the respective core system (1a, 1b, 1c), and, if necessary, further components as well as the necessary subsystems (7a, 7b, 7c) of the personal computer is performed by use of at least one switching element.

21. Personal computer according to one of the claims 18 to 20, characterized in that the switching element has well defined physical switching positions, preferable self-locking switching positions, for example in a locking form or in the form of an electrical or optical switch, for example an opto coupling device, whereby especially for each present subsystem (8) at least one locking position is present.

22. Personal computer according to one of the claims 18 to 21, characterized in that the switching element is at least one directly operable mechanical switching element, for example a rotary switch, a slide switch, a toggle switch, a rocker switch, a pedal, a push button, including any combination thereof.

23. Personal computer according to one of the claims 18 to 22, characterized in that the switching element is designed as directly operable combination switch, in particular such a combination switch, which is swiveling, turnable or tiltable around a center or around an axle or around several axles, or is movable on one or more straight levels or on one or more curved surface of any shape, including any combination thereof.

24. Personal computer according to claim 23, characterized in that the combination switch has an integrated protection against unintentional manipulation, in particular for certain switching positions.

25. Personal computer according to one of the claims 23 to 24, characterized in that the combination switch on one hand
allows the direct selection of any subsystem (8), for example through turning of a switch, and on the other hand
effects at the same time also the obligatory putting out of operation of the respective core systems (1a, 1b, 1c) and if necessary of further components of the personal computer over at least one switching element, for example by axial shifting of the switching element along its rotation axle.

26. Personal computer according to one of the claims 18 to 25, characterized in that the switching element is either a mechanical, an electrical, an electronic, a piezoelectric, an optical, an acoustic or a magnetic element, including any combination thereof, for example a relay.

27. Personal computer according to one of the claims 18 to 26, characterized in that the switching element, depending on its installation in the personal computer or in the physical removable carrier or in the integral module of autonomously usable storage media (9), is either directly manually operable or is indirectly controllable over an actuator arranged separately from the switching element, whereby the control is preferably done in a manner which is not observable or influenceable by third party, for example by a particularly designed and if necessary shielded autonomous wiring.

28. Personal computer according to one of the claims 18 to 27, characterized in that the control of the switching element is done using a remote control, preferably over an individualized or personalized remote control, which is neither to be influenced nor to be manipulated by third party, for example over a separate remote control or over a computer mouse, which is directly connected with the personal computer, preferably over such a computer mouse, which is equipped with a separate actuator, for example in the form of a rocker switch, with which the change from a subsystem (8) to any another subsystem (8) can be done.

29. Personal computer according to one of the claims 18 to 28, characterized in that for the complete or partial, direct or indirect manipulation of the switching element the use of a key is necessary, whereby this key is preferably in the form of a mechanical, electrical, electronic, piezoelectric, optical, acoustic or magnetic, active or passive element, including any combination thereof.

30. Personal computer according to one of the claims 18 to 29, characterized in that the switching element is directly or indirectly, completely or partly operable in the personal computer or outside of the personal computer either
by bringing in or by removing at least one physically separate removable carrier, preferably in an individualized or personalized form, or
by bringing in or by removing at least one storage medium (9) in the form of a physically separate removable storage unit, preferably in an individualized or personalized form, for example in the form of a storage sub module.

31. Personal computer according to one of the claims 18 to 30, characterized in that the switching element is operable directly or indirectly, completely or partly in combination with the shifting or by rotating of the component containing the respective core systems (1a, 1b, 1c) against to the personal computer, in particular by shifting or by the rotating of the component with the respective core systems (1a, 1b, 1c) against to the subsystems (8), which are contained in the personal computer.

32. Personal computer according to one of the claims 18 to 31, characterized in that the switching element is operable directly or indirectly, completely or partly either
by shifting or by rotating of at least one component with the subsystem (8) against the personal computer, or
by shifting or by rotating of at least one physically removable carrier against the personal computer, or
by shifting or by rotating of at least one integral module, which is self contained, of autonomously usable storage media (9) against the personal computer, or
by shifting or by rotating of the component with the respective core systems (1a, 1b, 1c) against the personal computer,
including any combination thereof.

33. Personal computer according to one of the claims 18 to 32, characterized in that
either the switching element and at least one subsystem (8) or the switching element and the respective core system (1a, 1b, 1c) are integrated in such a manner into a module that this module is movable against the cabinet of the personal computer in at least one straight level or in one curved surface of any shape, or is swivelable, turnable or tiltable around at least one center or around one axle,
that both the selection of the switching position and the start-up of the respective selected subsystem (8) as well as the physical access to the further peripheral data readers and data memory devices, assigned to a certain subsystem (8), is done directly or indirectly either
by shifting, turning, tilting or swiveling of the module against the cabinet of the personal computer or
by shifting, turning, tilting or swiveling of the cabinet of the personal computer against the surrounding environment or by a connection of the module or of the cabinet with its surrounding environment, for example in the form of a table or of a docking station,
and
that the chosen position of the module and of the thereby selected mode of operation of the personal computer is evident and/or is indicated visually for example on a display connected with the personal computer, either
at the position of the module in connection with its surrounding cabinet or
the position of the surrounding cabinet in connection with its surrounding environment or
by a connection of the module or of the cabinet with its surrounding environment.

34. Personal computer according to one of the claims 1 to 33, characterized in that together with the subsystems (8) also
all or a partial amount of the serial and/or parallel, analogue and/or digital interfaces, respectively the incoming and/or outgoing connections, and/or the internal connections, bus, which are present in the personal computer,
and/or the supply for the components, which are installed in the personal computer, for example internal modems, transmission cards, I/O cards, for example network interface cards, preferably in the form of a separate network interface card of different designs per subsystem (8),
are wired over at least one switching element, in particular over that switching element, with which the change from a subsystem (8) to another subsystem (8) is done, and that said interfaces, connections, transmission cards, and I/O cards may be connected or disconnected accordingly at the same time with the respective selected subsystem (8),
whereby all network interface cards are arranged centrally preferably on a separate board in the rear of the personal computer.

35. Personal computer according to one of the claims 1 to 34, characterized in that all or a partial amount of the serial and/or parallel, analogue and/or digital interfaces, respectively the incoming and/or outgoing connections, contained in a certain subsystem (8) of the personal computer, are not compatible against each other, in that either
different categories of data communication media, for example unshielded twisted pair cable, UTP cable, coaxial cable, optical fiber cable are used, or
by different versions not compatible against each other of the data communication media, that belong to the same category, for example by their different geometrical design of the transmission links and connection elements, for example plugged connections.

36. Personal computer according to one of the claims 1 to 35, characterized in that together with the storage media (9), that are present in the subsystems (8), also
at least one of the further in the personal computers contained or to this personal computer connected peripheral data readers and data memory devices, for example floppy disk drives, CD-R drives, CD-RW drives, memory-card readers, streamers, which for the additional storage of data on separate, individual storage media (9) of different categories, for example disks, CD-R, CD-RW, memory sticks, memory cards, magnetic tapes, especially in the form of streamer cassettes, must be inserted for this purpose temporarily into said further peripheral data readers and data memory devices,
is also directly wired with a switching element, in particular by that switching element, with which the change from a subsystem (8) to another subsystem (8) is done, and
that these said further peripheral data readers and data memory devices may be connected or disconnected accordingly at the same time with the respective selected subsystem (8).

37. Personal computer according to claim 36, characterized in that at least one of the subsystems (8) together with the further peripheral data readers and data memory devices that belong to the PC, is designed in such a manner, that for the prevention of unintentional data exchange from a first subsystem (8) to any further subsystem (8) the individual storage media, which must be brought temporarily into said further peripheral data readers and data memory devices, are designed to be incompatible against each other, for example by use of different categories of storage media, for example disks, CD-R, CD-RW, memory sticks, memory cards, magnetic tapes, in particular in the form of streamer cassettes, or by different incompatible versions of the further peripheral data readers and data memory devices, which belong to the same category, for example by different geometrical shapes.

38. Personal computer according to one of the claims 1 to 37, characterized in that at least one of the subsystems (8) together with the further peripheral data readers and data memory devices, which belong to it, is designed in such a manner, that for the prevention of unintentional data exchange from a first subsystem (8) to any further subsystem (8) at least two of said further peripheral data readers and data memory devices are partially compatibly against each other, but exclusively allow a selective data transfer, in that either
the respective drives are designed as “read only drives” or as or as “memory only drives”, or
only the reading functions or only the memory functions of the respective drives are controllable by the respective software, or
that in the presence of a combined “read and memory drive” as desired either the read function or the memory function of the respective drive, preferably the memory function, can be operated only through a permanent activation of an additional element during the desired procedure, for example through pressing of a separate key which is located near the corresponding data memory device,
including any combination thereof.

39. Personal computer according to one of the claims 36 to 38, characterized in that the physical access to the further peripheral data readers and data memory devices, that belong to a certain subsystem (8), is only possible when the corresponding subsystem (8) is selected, whereas the other present peripheral data readers and data memory devices, are completely inaccessible and remain inaccessible, in particular in the form of at least one shiftable mechanical cover, which is swiveling, turnable or tiltable around at least one center or around at least one axle or around several axles, or is movable in a straight level or in several straight levels or in one or more curved surface of any shape, including any combination thereof.

40. Personal computer according to claim 39, characterized in that the change of the position of the mechanical cover is coupled with the direct or indirect actuation of a switching element in such a manner that either
the swiveling, turning, tilting and moving of the mechanical cover causes simultaneously the actuation of the switching element, or
the actuation of the switching element causes the corresponding swiveling, turning, tilting and moving of the mechanical cover.

41. Personal computer according to one of the claims 1 to 40, characterized in that it comprises two from each other independent subsystems (8), in particular
a first autarkic, autonomous subsystem (8), which is completely and permanently separated from all external and internal network data streams and is exclusively denoted for the operation with safety-relevant data, the so-called mode of operation “safe”, which corresponds in fact to a completely isolated “stand alone” personal computer, and
a second autonomous subsystem (8), which is wired and connected, respectively with wire-bound means of communication, for example internet, fax, telephone, intranet, ethernet, universal standard bus, USB, or with wireless means of communication, for example infrared, wireless, including any combination thereof, the so-called mode of operation “open”, and
that a switching element is present, which has switching positions in the order “safe”, “off”, “open”, and that the chosen switching position is obvious either at the switching element itself or its actuator and/or is indicated visually, for example on a display connected with the personal computer.

42. Personal computer according to one of the claims 1 to 40, characterized in that it comprises two from each other independent subsystems (8), in particular
a first autonomous subsystem (8), which is wired and connected, respectively with an self contained, autarkic internal network, for example an internal network of an enterprise or a segment of such a network, of either analogously equipped personal computers or correspondingly configured “stand alone” personal computers, the so-called mode of operation “internal”, whereby the connections between the individual personal computers are made in such a manner, that in this mode of operation only personal computers may be selected internal, that are also operated in the mode of operation “internal” or are selected correspondingly, and
a second autonomous subsystem (8), which is wired and connected, respectively with wire-bound means of communication, for example internet, fax, telephone, intranet, ethernet, universal standard bus, USB, or with wireless means of communication, for example infrared, wireless, including any combination thereof, the so-called mode of operation “open”, and
that a switching element is present, which has switching positions in the order “internal”, “off”, “open”, and that the chosen switching position is obvious either at the switching element itself or its actuator and/or is indicated visually, for example on a display connected with the personal computer.

43. Personal computer according to one of the claims 1 to 40, characterized in that it comprises three from each other independent subsystems (8), in particular
a first autarkic, autonomous subsystem (8), which is completely and permanently separated from all external and internal network data streams and is exclusively denoted for the operation with safety-relevant data, the so-called mode of operation “safe”, which corresponds in fact to a completely isolated “stand alone” personal computer,
a second autonomous subsystem (8), which is wired and connected, respectively with a self contained, autarkic internal network, for example an internal network of an enterprise or a segment of such a network, of either analogously equipped personal computers or correspondingly configured “stand alone” personal computers, the so-called mode of operation “internal”, whereby the connections between the individual personal computers are made in such a manner, that in this mode of operation only personal computers may be selected internally, that are also operated in the mode of operation “internal” or are selected correspondingly, and
a third autonomous subsystem (8), which is wired or separately connected, either with external wire-bound means of communication, for example internet, fax, telephone, or with external wireless means of communication, for example infrared, wireless, including any combination thereof, the so-called mode of operation “open”, and
that a switching element is present, which has between the switching positions “safe”, “internal”, and “open” always a switching position “off”, preferably in the sequence “safe”, “off”, “internal”, “off”, “open”, and that the chosen switching position is obvious either at the switching element itself or its actuator and/or is indicated visually, for example on a display connected with the personal computer.

44. Personal computer according to one of the claims 1 to 40, characterized in that it comprises four from each other independent subsystems (8), in particular
a first autarkic, autonomous subsystem (8), which is completely and permanently separated from all external and internal network data streams and is exclusively denoted for the operation with safety-relevant data, the so-called mode of operation “safe”, which corresponds in fact to a completely isolated “stand alone” personal computer,
a second autonomous subsystem (8), which is wired and connected, respectively with a self contained, autarkic internal network, preferably a segment of an internal network of an enterprise, of either analogously equipped personal computers or correspondingly configured “stand alone” personal computers, the so-called mode of operation “work”, whereby the connections between the individual personal computers are made in such a manner, that in this mode of operation only personal computers may be selected internally, that are also operated in the mode of operation “work” or are selected correspondingly,
a third autonomous subsystem (8), which is wired and connected, respectively with an from said second autonomous subsystem (8) independent and self contained, autarkic internal network, for example an internal network of an enterprise or a segment of such a network, of either analogously equipped personal computers or correspondingly configured “stand alone” personal computers, the so-called mode of operation “internal”, whereby the connections between the individual personal computers are made in such a manner, that in this mode of operation only personal computers may be selected internally, that are also operated in the mode of operation “internal” or are selected correspondingly, and
a fourth autonomous subsystem (8), which is wired or separately connected, either with external wire-bound means of communication, for example internet, fax, telephone, or with external wireless means of communication, for example infrared, wireless, including any combination thereof, the so-called mode of operation “open”, and
that a switching element is present, which has between the switching positions “safe”, “work”, “internal” and “open” always a switching position “off”, preferably in the sequence “safe”, “off”, “work”, “off”, “internal”, “off”, “open”, and that the chosen switching position is obvious either at the switching element itself or its actuator and/or is indicated visually, for example on a display connected with the personal computer.

45. Personal computer according to one of the claims 42 to 44, characterized in that for those modes of operation, that belong not to an autarkic, autonomous subsystem (8), one separate network interface card is present per subsystem, whereby each network interface card preferably has a different design with different network connections, plugs and driver data, and whereby the driver data is installed only on the corresponding appropriate subsystem (8), and that all network interface cards in dependency of the respectively selected mode of operation are also selectively connected or interrupted accordingly by the switching element.

46. Personal computer according to one of the claims 42 to 44, characterized in that at least two of the possible modes of operation, for example “work” and “internal”, are located together in a subsystem (8), and are preferably located on different partitions of a hard disk.

47. Personal computer according to one of the claims 42 to 44, characterized in that with the exception of the first autarkic, autonomous subsystem (8), the so-called mode of operation “safe”, which corresponds in fact to a completely isolated “stand alone” personal computer, at least one of the further subsystems (8) is protected by additional tools, for example coding software, cryptographic software, against unauthorized access to data.

48. Personal computer according to one of the claims 1 to 47, characterized in that all changes in the hardware configuration of an individual subsystem (8), made after the last start-up of the personal computer, are recognized during the start-up of the personal computer and are shown in the form of a warning message on a display connected with the personal computer, and that these changes must be confirmed and be released for use through an appropriate authentication before the operation of the respective subsystem (8) in a distinct manner and in correspondence with the individualized or personalized form of the subsystem (8), whereby the authentication and release is preferably done in an appropriate, protected form with regard to the sensitivity of the subsystem (8), for example in the form of a biometric recognition or by a personal password.

49. Personal computer according to one of the claims 19 to 48, characterized in that over an autonomous interface management, contained in the personal computer,
all or any partial amount of the serial and/or parallel, analogue and/or digital interfaces respectively the incoming and/or outgoing connections, for example internal modems, transmission cards, I/O cards, for example network interface cards, preferably in the form of a separate network interface card of different design per subsystem (8), as contained in the personal computer, are autonomously supplied with power, supported and individually operated, and that
only those connections together with the respectively selected subsystem (8) can be activated, which are in connection with the switching element, in particular with this switching element, with which the change is performed from a first subsystem (8) to a further subsystem (8).

50. Personal computer according to claim 49, characterized in that by the autonomous interface management the further subsystems (8), that by their standby units are held in a separate standby mode, may also, together with the appropriate transmission cards, I/O cards, for example network interface cards, be simultaneously and autonomously connected with networks and may be operated individually over these networks after a previous clearance by the respective user of the respective personal computer.

51. Personal computer according to one of the claims 1 to 50, characterized in that by an autonomous network management, which is contained in the personal computer,
all or any segment of the autonomous internal networks connected with the personal computer and the further network management connected therewith are separately and autonomously supplied with power, buffered and individually operated, and that
the autonomous internal networks and the therewith indirectly connected further subsystems 8 which are in the mode of operation or in the standby mode are permanently monitored in regard to their hardware integrity and their allocation to a specific subsystem (8), and that
the actual operating mode of the autonomous internal networks and the actual operating mode of the applicable subsystems (8) are indicated either on a separate display at the personal computer or on a display connected with the personal computer.

52. Personal computer according to claim 51, characterized in that all changes in the hardware configuration of the autonomous internal network and of the subsystems (8), made after the last-up of the personal computer, which are indirectly connected with these networks or which are in a standby mode, are monitored in regard to their hardware integrity and their allocation to a specific subsystem (8), and that any changes are recognized and will be indicated in the form of a warning message on a display connected with the personal computer, and that these changes must be accepted and released for use through a corresponding authentication before the initial start-up of the respective subsystem (8), and in agreement with the individualized or personalized form of the subsystem (8), whereby the authentication and the release is preferably done in such a manner, which is in accordance to the sensitivity of the subsystem (8), and will be performed in an appropriate, protected form, for example in the form of a biometric recognition or by a personal password.

53. Personal computer according to one of the claims 1 to 52, characterized in that it is equipped with such means, which allow an active and/or passive detection, a sequential or permanent detection concerning its absolute geographical location or its relative locational changes, for example in relation to real estates or to vehicles or to further similar equipped personal computers, whereby these means are preferably selected from the group consisting of
communication devices, for example in the form of global system for mobile communications, GSM,
navigation devices, for example in the form of a global positioning system, GPS, and
physical sensors for the measurement of changes of position, for example in the form of sensors to the barometric pressure measurement, in particular altimeters,
including any combination thereof.

54. A kit for upgrading of existing personal computers for the achievement of the extended functionality of the personal computers, preferably for their stationary embodiments, according to one of the claims 1 to 53, characterized in that this kit comprises at least one switching element, which is equipped with the correspondingly configured cables and plugs for the simple setup of the connections between “main board” and the hard disks as well as the occasionally needed interfaces, transmission cards, I/O cards and actuators, if necessary in combination with additional storage media (9), for example hard disk drives, HDD, as well as the further occasionally needed elements, for example integrated or adaptive interface managements and network managements, and
personal computers, comprising this kit.

55. A kit for upgrading of existing personal computers for the achievement of the extended functionality of personal computers, preferably for their mobile embodiments, for example laptops, handhelds, according to one of the claims 1 to 53, characterized in that this kit has the form of a pre-assembled cabinet, which comprises a switching element and its cabeling as well as pre-assembled modules, and the occasionally needed additional components in the form of at least one hard disk, as well as the further occasionally needed elements, for example integrated or adaptive interface managements and network managements, and
personal computers, comprising this kit.

56. A kit for upgrading of existing personal computers for the achievement of the extended functionality of personal computers according to one of the claims 1 to 53, characterized in that this kit comprises at least two autonomous storage media (9) in the form of at least one integral module,
whereby in this module is integrated preferably the switching element, and whereby this kit comprises occasionally further needed additional components,
for example correspondingly preassembled cables and plugs for the setup of the connections between the integral module and the “main board”, as well as correspondingly preassembled cables and plugs for the setup of the connections to the occasionally needed interfaces, transmission cards, I/O cards and actuators, and
personal computers, comprising this kit.
